(19) United States
(12) Patent Application Publication
(10) Pub. No.: US 2016/0050282 A1
(43) Pub. Date: Feb. 18, 2016

(54) METHOD FOR EXTENDING HYBRID HIGH AVAILABILITY CLUSTER ACROSS NETWORK

(71) Applicant: SOFTNAS, LLC, Houston, TX (US)

(72) Inventor: Eric OLSON, Melbourne, FL (US)

(73) Assignee: SOFTNAS, LLC, Houston, TX (US)

(21) Appl. No.: 14/829,441

(22) Filed: Aug. 18, 2015

Related U.S. Application Data
(60) Provisional application No. 62/038,713, filed on Aug. 18, 2014.

(51) Int. Cl. H04L 29/08

(52) U.S. Cl. CPC H04L 67/16; H04L 67/141; H04L 67/1095

(57) ABSTRACT

Method and apparatus for switching between a first server and a second server, each located within a virtual private cloud and the first server being located within a first zone and the second server being located within a second zone that is physically separate from the first zone. The method and apparatus can be configured to determine that the first server has experienced a failure to send or receive data. The method and apparatus can be further configured to enable a second port on the second server. The method and apparatus can be further configured to create a new route table at the second server and flush the previous rout table, as well as transmit, via the second port, a request to a virtual private cloud controller to update an elastic internet protocol address with the second port information and receive data from the virtual private cloud controller.

### CROSS-REFERENCE TO RELATED APPLICATION

This application claims priority to U.S. Provisional Application No. 62/038,713 filed Aug. 18, 2014, the contents of which are entirely incorporated by reference herein.

### FIELD

The subject matter herein generally relates to providing cloud computing solutions and protection of user data.

### BRIEF DESCRIPTION OF THE DRAWINGS

Implementations of the present technology will now be described, by way of example only, with reference to the attached figures, wherein:

FIG. 1 is an example of a possible system architecture implementing the current disclosed subject matter.

FIG. 2 is an example of a particular implementation according to the present technology.

FIG. 3 is an example of a particular implementation according to the present technology.

FIG. 4 is an example of a method according to the present disclosure.

### DETAILED DESCRIPTION

For simplicity and clarity of illustration, where appropriate, reference numerals have been repeated among the different figures to indicate corresponding or analogous elements. In addition, numerous specific details are set forth in order to provide a thorough understanding of the implementations described herein. However, those of ordinary skill in the art will understand that the implementations described herein can be practiced without these specific details. In other instances, methods, procedures and components have not been described in detail so as not to obscure the related relevant feature being described. Also, the description is not to be considered as limiting the scope of the implementations described herein.

Several definitions that apply throughout this disclosure will now be presented. The term coupled is defined as directly or indirectly connected to one or more components. The term server can include a hardware server, a virtual machine, and a software server. VMware ESXi is an enterprise-class, type-1 hypervisor for deploying and serving virtual computers. As a type-1 hypervisor, ESXi is not a software application that one installs in an operating system; instead, it includes and integrates vital OS components, such as a kernel.

At least one embodiment of this disclosure is a software-defined Network-attached storage (NAS) Filer delivered as a virtual storage appliance that can run across ESXi and VMware vCloud Hybrid Service (vCHS) environments. The embodiment provides enterprise-grade NAS capabilities, including cross-datacenter high-availability with automatic failover in order to prevent loss of data flow within relevant systems.

At least one embodiment within this disclosure enables deployment of hybrid clouds using VMware and/or vCloud Hybrid Service. In at least one embodiment, vCHS and ESXi data centers can be connected at a storage layer. vCHS and/or ESXi data centers can be configured to replicate data in near real-time for off-site backup and data recovery (DR). Unique Hybrid HA enables flexible operation of workloads seamlessly across premise and cloud data centers for non-stop virtualization and storage services spanning the secure hybrid cloud.

At least one embodiment within this disclosure pertains to applications that are purely cloud-hosted in vCHS. In this situation, the enterprise-grade NAS features and cloud storage extensions can be provided to support a broad range of use cases, such as, but not limited to, SaaS and other applications that are “born” in the cloud. SoftNAS Cloud runs as a virtual storage appliance within ESXi and vCHS. At least one embodiment within this disclosure includes NAS filer features on top of block and cloud object storage as NFS, CIFS and iSCSI shared storage. The embodiment can be further combined with VMware and vCHS technology to yield seamless hybrid clouds.

The present technology can be configured to comprise two or more servers located within a Wireless Area Network (WAN). Two of the two or more servers are located within different locations within the WAN. For example, the WAN can be defined within a large area with the two servers located some distance apart. In at least one embodiment, a high availability cluster comprises the two or more servers. In at least one implementation, the high availability cluster spans two locations such that both locations have access to information stored on the high availability cluster. In another embodiment, the two locations are connected to the high availability cluster via VxLAN or Data Center Extender (DCE) connections. The present technology comprises at least two servers that are configured such that one of the servers is a primary server and the other server is a backup or redundant server, such that all of the data that is present on the first server is also present on the second server. For example, the second server can be a minor storage device of the first server.

The present technology is configured to provide a seamless failover in the event that the first server is not able to send and/or receive data, with a client device; the communication from the client device is routed over to the second server. In at least one implementation, the switch over to the second server is such that it can be made such that there is no disruption of communication from the client to data stored on the two servers.

In at least one embodiment, the present technology can be implemented as a software module or as a hardware module or as a combination of both. In at least one embodiment, the present technology causes a processor to execute instructions. The software module can be stored within a memory device or a drive. The present technology can be implemented with a variety of different drive configurations including Network File System (NFS), internet Small Computer System Interface (iSCSi), and Common Internet File System (CIFS). Additionally, the present technology can be configured to run on VMware ESXi (which is an operating system-independent hypervisor based on the VMkernel operating system interfacing with agents that run on top of it). Additionally, the present technology can be configured to run on Amazon® Web Service in VPC.

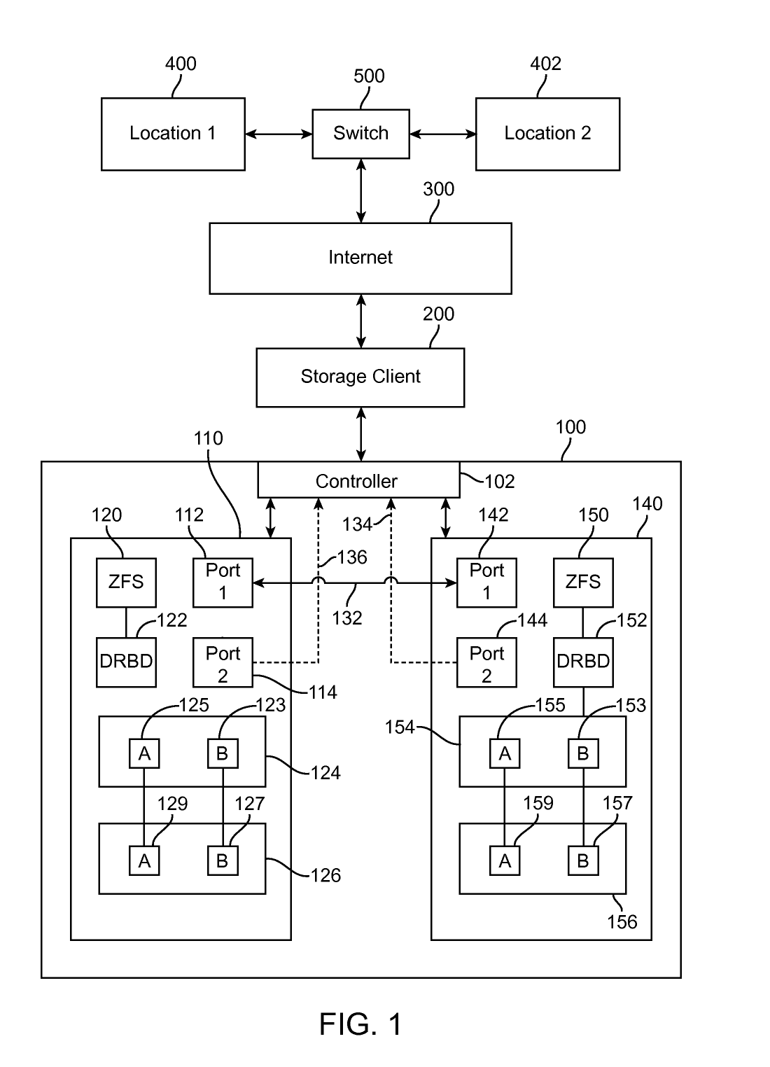

At least one embodiment of the present technology can be configured to extend a high availability cluster across a WAN, the high availability cluster having seamless cross-zone failover. An example of the present disclosure is illustrated in FIG. 1. A WAN 100 is illustrated. The WAN 100 comprises a controller 102. The controller 102 can control the first server 110 and the second server 140. While only two servers are illustrated in the present example, the technology can be implemented with two or more servers. The illustration of only two servers is provided to simplify the presentation of information. The controller 102 can be communicatively coupled to a storage client 200. The storage client 200 can be a web server, for example a hypertext transfer protocol (HTTP) server. In other embodiments, other types of storage clients can be implemented. In other embodiments, the storage client 200 can be configured to allow for pass through of data and from other locations (400, 402) and/or other devices. The storage client 200 or other device can be communicatively coupled to the internet 300.

The internet 300 can be communicatively coupled to a switch 500. In other embodiments, depending on a user's connection capabilities, the switch 500 can be a VxLAN (layer 2 extension over a layer 3 connection) or DCE (layer 3 extension over a VPN tunnel) connection. Additionally, as illustrated, two or more locations can connect to the internet 300 through the switch 500. While only two locations are illustrated in the present example, the technology can be implemented with two or more locations. The illustration of only two locations is provided to simplify the presentation of information. The locations can include a first location 400 and a second location 402. In one version, the first location is a physical location. In another version the second location provides a cloud computing service to the first location. In at least one embodiment, the first location is a VMware ESXi Datacenter, and the second location is a vCloud Hybrid Service. Other devices at other locations that need access to storage client 200 are also considered within this disclosure. The other devices can include tablets, laptops, servers, navigation devices, electronic systems within an automobile, and other special purpose devices.

The first server 110 can comprise a first communication port 112 and a second communication port 114. The first communication port 112 and the second communication port 114 can be any interface that is designed to communicate with a corresponding communication interface on another device that allows for communication between the devices. In one example, the first communication port 112 and the second communication port 114 can be network interface cards (NICs). In other configurations the first communication port 112 and the second communication port 114 can be other devices that allow for transfer of data including universal serial bus, Ethernet, optical data cards, and the like. While the first communication port 112 and the second communication port 114 can be the same type of port, in other implementations, the ports 112, 114 can be different.

The second server 140 can comprise a first communication port 142 and a second communication port 144. The first communication port 142 and the second communication port 144 can be any interface that is designed to communication with a corresponding communication interface on another device that allows for communication between the devices. In one example, the first communication port 142 and the second communication port 144 can be network interface cards (NICs). In other configurations the first communication port 142 and the second communication port 144 can be other devices that allow for transfer of data including universal serial bus, Ethernet, optical data cards, and the like. While the first communication port 142 and the second communication port 144 can be the same type of port, in other implementations, the ports 142, 144 can be different.

As illustrated the first communication port 112 of the first server 110 can be configured to be communicatively coupled 132 with the first communication port 142 of the second server 140. The communicative coupling of the first server 110 with the second server 140 allows for data to be transferred between the first server 110 and the second server 140. This allows for the data on the second server 140 to be a minor of the data on the first server 110, thereby providing a backup to the data on the first server 110.

The controller 102 can be configured to direct data traffic to the first server 110 or the second server 140 based upon an elastic internet protocol address (EIP).

The first server 110 can further include a zone file system (ZFS) 120. ZFS can be configured to communicate with a distributed replicated block device (DRBD) 122 on the first server 110. The DRBD 122 can be configured to communicate with DRBD devices 124 such as a first disk device A 125 and a second disk device B 123. Additionally, the server can comprise an elastic block storage (EBS) unit 126. The EBS 126 can comprise a first volume A 129 and a second volume B 127. The EBS first volume A 129 can be communicatively coupled to the first disk device A 125. The EBS second volume B 127 can be communicatively coupled to the second disk device B 123.

The second server 140 can further include ZFS 150. The ZFS can be configured to communicate with a DRBD 152 on the second server 140. The DRBD 152 can be configured to communicate with DRBD devices 154 such as a first disk device A 155 and a second disk device B 153. Additionally, the server can comprise an EBS 156. The EBS 156 can comprise a first volume A 159 and a second volume B 157. The EBS first volume A 159 can be communicatively coupled to the first disk device A 155. The EBS second volume B 157 can be communicatively coupled to the second disk device B 153.

In normal operation, the first server 110 is communicatively coupled to the controller 102 via a second port 114 over communication channel 136. Additionally, data that is being accessed at the first server is stored on the first disk device A 125 and the first volume 129. This data is replicated to the second server 140 via the first ports 112, 142 over communication channel 132. The replicated data is stored on the second server 140 in the first disk device A 155 and first volume A 159. The data stored on the second disk device B 123 and the second volume 127 is the backup or replication of the data on second server 140 on second disk device B 153 and the second volume 157.

If it is detected that the first server 110 has lost communication and/or connectivity, (as by for example the controller 102 and/or the second server 140), the second server 140 enables the second port 144 to communicate with the controller 102 via communication channel 134. The second server 140 sends information to the controller 102 to update the EIP so that communication can flow to the second server 140 instead of the first server 110. As described below, the transformation of the EIP can be as a result of the second server 140 creating a new route table and flushing the old route table. Once the EIP is updated, the data that was originally being directed towards the first server 110 is directed to the first disk device 155 and the first volume 159, so that the locations 400, 402 do not experience any delay in accessing or storing data and the data set remains complete.

In one version, because both locations 400, 402 are connected to the controller 102, if one location fails, the other location will not experience any delay in accessing or storing data to the servers 110, 140, which are themselves protected by a failover.

While the above has used volumes and disk devices to describe the EBS and DRBD devices, these terms can refer to one or more files or one or more devices. Additionally, the controller 102 has been described within the WAN 100; however the controller 102 can be located outside of the WAN. While the above has been described in relation to servers, other types of structures are considered within this disclosure.

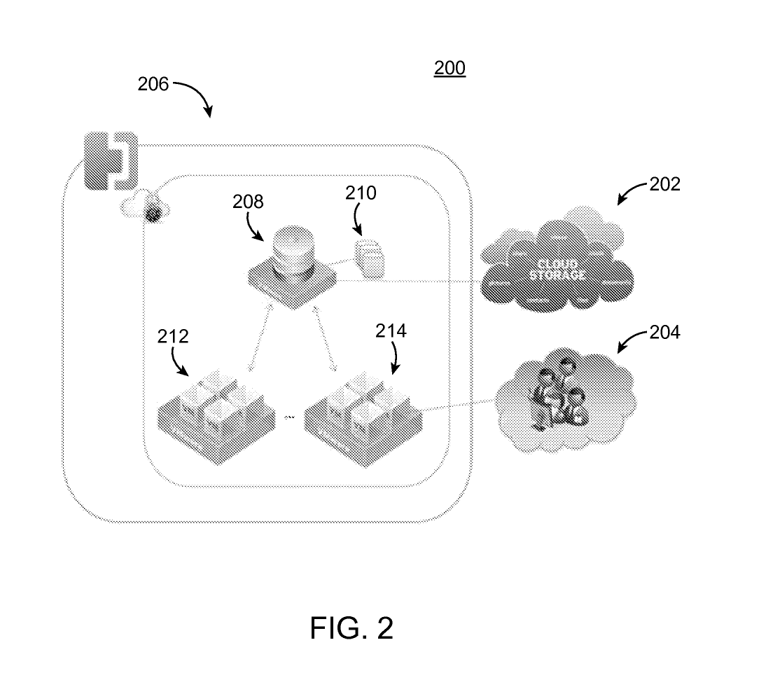

FIG. 2 illustrates an example of the present technology operating within a specific configuration 200. The examples of VMware file structures illustrated can be NFS, CIFS, iSCSi or the like as described above. The VMware files can be SaaS applications, mobile applications, cloud desktops, or the like as used in cloud computing. As shown, a vCloud Hybrid Service 206 can comprise a SoftNAS Cloud™ 208 coupled to two or more VMware file structures (212, 214). Hybrid Service 206 can also include SSD/Disks, coupled to the SoftNAS Cloud™ 208. One or more of the VMware file structures (212, 214) can be coupled to one or more SaaS applications, mobile applications, cloud desktops, and the like (202, 204).

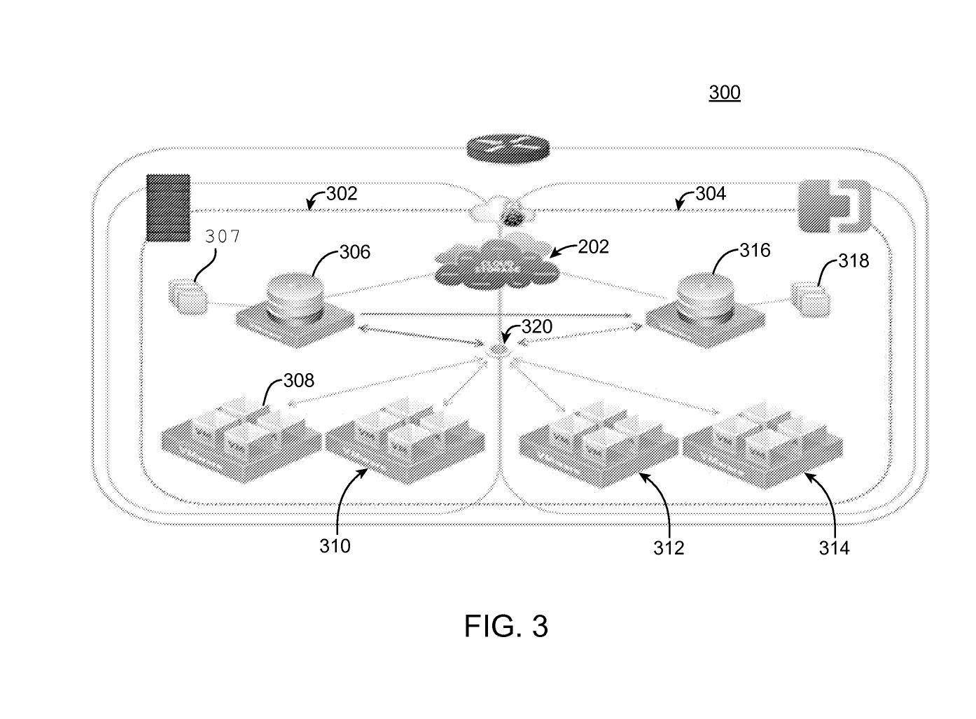

FIG. 3 illustrates an example of the present technology operating within a specific configuration 300. The examples of VMware file structures illustrated can be NFS, CIFS, iSCSi or the like as described above. The VMware files can be SaaS applications, mobile applications, cloud desktops, or the like as used in cloud computing. FIG. 3 illustrates a SoftNAS Cloud™ Controller A 306 within a VMware ESXi Datacenter 302 and a SoftNAS Cloud™ Controller B 316 within a vCloud Hybrid Service 304 are coupled together via a VxLAN to a cloud storage 202. Datacenter 302 can comprise Controller A 306, coupled and SSD/Disks 307. Datacenter 302 can further comprise VM Ware (308, 310). Hybrid service 304 can comprise a controller 316 coupled and SSD/Disks 318. The two controllers (306, 316) can be coupled to one another to provide fail-over capability as described above. The two controllers (306, 316) can be coupled to cloud storage 202. The two controllers (306, 316) and the VM Ware modules (308, 310, 312, 314) can each be coupled a virtual IP address 320, such as SNAP HA Virtual IP. As each of these elements is coupled to SNAP HA Virtual IP 320, they are effectively communicatively coupled to one another as well.

The data in Controller A 306 can be replicated over to Controller B 316. In the event the VMware ESXi Datacenter 302 fails, the data and applications can still be accessed on the cloud storage 202, and vice versa.

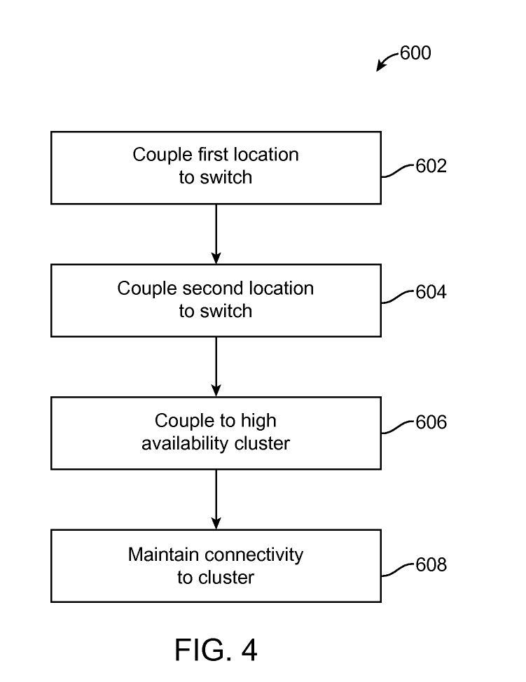

The present disclosure also includes a method 600 relating to the technology illustrated in FIGS. 1-3. As illustrated in FIG. 4, the method 600 includes several steps. The steps illustrated are for illustration purposes and other steps can be implemented. Additionally, while a particular order is illustrated in FIG. 4, the present technology can be implemented in other arrangements such that the order of the steps can be different than that as illustrated. Furthermore, the present technology can include steps that are not illustrated and other embodiments can be such that one or more of the steps are removed. The method is described in relation to two locations, which can comprise any computing devices as described above. For example, the servers as described below can be network attached storage devices.

The method comprises connecting a first location to a switch (block 602). The first location can be a VMware ESXi Datacenter. The switch can be configured to support either a VxLAN or DCE connection.

The method can further comprise connecting a second location to the switch (block 604). The second location can be a vCloud Hybrid Service.

The method can further comprise connecting to a high availability cluster (block 606). The high availability cluster can comprise a controller and two or more servers in a WAN.

The method can further comprise maintaining the connection to the high availability cluster in the event one of the locations fails (block 608).

The attached appendix illustrates particular examples of the technology according to this disclosure.

Examples within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other examples of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Examples may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein apply not only to a smartphone device but to other devices capable of receiving communications such as a laptop computer. Those skilled in the art will readily recognize various modifications and changes that may be made to the principles described herein without following the example embodiments and applications illustrated and described herein, and without departing from the scope of the disclosure.

What is claimed is:

1. A method of extending a high availability cluster across a wide area network (WAN) between a first location and a second location comprising:
connecting a first location to a switch, the first location being a physical location;
connecting a second location to the switch, the second location providing a cloud computing service to the first location; and
communicating between the switch and the high availability cluster by using either a layer 2 or layer 3 extension;
wherein the cloud computing service becomes available at the high availability cluster.

2. The method of claim 1 wherein the layer 2 extension comprises a VxLAN.

3. The method of claim 1 wherein the layer 3 extension comprises a Data Center Extender (DCE).

4. A wide area network (WAN) comprising:
a switch,
a first location comprising a physical location, the first location connected to the switch;
a second location, connected to the switch, the second location providing a cloud computing service to the first location; and
a high availability cluster,
wherein the switch and the high availability cluster are configured such that communications between the switch and the high availability cluster utilize either a layer 2 or layer 3 extension; and
wherein the cloud computing service is configured to be available at the high availability cluster.

5. The WAN of claim 4, wherein the layer 2 extension comprises a VxLAN.

6. The WAN of claim 5, wherein the layer 3 extension comprises a Data Center Extender (DCE).

7. The WAN of claim 4, wherein the layer 3 extension comprises a Data Center Extender (DCE).

8. A server system including two or more servers, the server system configured to prevent data loss, the system comprising:
at least one primary server;
at least one backup server, the backup server configured such that all data present on the primary server is also present on the backup server,
wherein the primary server and the backup server are located within different locations within a wireless area network (WAN), the WAN defined within a large area, the two servers separated by a predetermined distance.

9. The server system of claim 8, wherein the backup server is a mirror storage device of the first server.

10. The server system of claim 8, wherein the at least two or more servers reside within a high availability cluster.

11. The server system of claim 10, wherein the high availability cluster spans two locations, both of which have access to information stored on the high availability cluster.

12. The server system of claim 11, wherein the two locations are connected to the high availability cluster via VxLAN or Data Center Extender (DCE) connections.
